(19) United States
(12) Patent Application Publication
(10) Pub. No.: US 2023/0145513 A1
(43) Pub. Date: May 11, 2023

(54) TETHER ANCHOR ASSEMBLY FOR VEHICLE

(71) Applicants: Hyundai Motor Company, Seoul (KR); Kia Corporation, Seoul (KR)

(72) Inventors: Suk Won Hong, Bucheon (KR); Sang Hyeok Yun, Ulsan (KR); Sung Man Seo, Suwon (KR); Sung Hak Hong, Suwon (KR); Jong Seok Han, Suwon (KR); Ji Sun Lee, Yongin (KR)

(21) Appl. No.: 17/982,075

(22) Filed: Nov. 7, 2022

(30) Foreign Application Priority Data
Nov. 8, 2021 (KR) 10-2021-0151940

(51) Int. Cl. B60N 2/28

(52) U.S. Cl. CPC B60N 2/2809

(57) ABSTRACT

Provided is a tether anchor assembly for a vehicle including a seat frame including a support panel coupled to a back frame, the support panel including an anchor groove provided therein, and a mounting wire exposed to an outside through the anchor groove, and a tether cover configured to allow the mounting wire to be fitted and coupled to an inside thereof and to be exposed to the outside through the anchor groove when inserted into the anchor groove, and to be directly coupled to the support panel to fix a position of insertion thereof into the anchor groove.

### CROSS-REFERENCE TO RELATED APPLICATION

This application claims under 35 U.S.C. § 119(a) the benefit of Korean Patent Application No. 10-2021-0151940 filed on Nov. 8, 2021, the entire contents of which are incorporated herein by reference.

### TECHNICAL FIELD

Embodiments of the present disclosure relate to a tether anchor assembly for a vehicle. More particularly, it relates to a tether anchor assembly for a vehicle capable of reducing the number of components for assembly of a tether anchor mounted on a rear seatback and simplifying a structure of an assembly of the tether anchor.

### DESCRIPTION OF THE RELATED ART

In general, it is mandatory to fasten a seat belt in order to ensure the safety of an occupant in the event of a vehicle accident. However, since infants and children have significantly different physiques from adults, the seat belt of the related art fails to guarantee the safety of the infant and child, and may cause more serious injuries depending on the situation.

Therefore, a child seat is installed on a seat (typically a rear seat) of a vehicle, and the infant or child is seated thereon. In this case, in order to ensure safety, it is very important to confirm that the child seat is firmly fixed.

A cushion of the child seat is fixed to a latch bar configured to fix the seat belt or to an anchor provided at a boundary position between a cushion of the rear seat and a seatback. Further, a seatback of the child seat is fixed by connecting a tether latch, which is referred to as a top tether, to a tether anchor provided on a rear package tray or a back panel of a rear seatback.

Typically, the tether anchor includes a mounting unit, configured to fix the tether anchor to a fixing portion such as the back panel of the seatback with bolts, and a striker, formed to be integrated with the mounting unit and coupled with the tether latch.

Here, the tether anchor is installed at an inside of a back panel surface of the seatback to improve the appearance of an installation portion and to prevent interference with other components. In addition, the tether anchor is exposed to the outside through an open hole formed in the back panel to be coupled to the tether latch (that is, the tether anchor is installed so as not to protrude outwards from the back panel surface).

However, since the open hole is formed in the back panel as described above, the interior of the seat is visible from the outside. Accordingly, the external beauty of the seat deteriorates (deterioration in luxuriousness), which is a factor that significantly degrades the luxuriousness of an interior design of the vehicle.

Therefore, a tether anchor cover is installed to cover the open hole around the striker while the striker of the tether anchor is exposed to the outside, thereby preventing deterioration in external beauty.

However, when the tether anchor cover is additionally installed to cover the open hole therearound, the number of components required to fix the tether anchor cover may increase depending on shape characteristics of the tether anchor cover. Therefore, it is important to simplify the structure of the tether anchor cover in order to facilitate installation thereof

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a tether anchor assembly for a vehicle including an integrated wire capable of guiding mounting of a child seat and fixing a back frame and a panel, the integrated wire being installed in the back frame, which determines the rigidity of a seat, and being exposed to an outside through an anchor groove, and a tether cover fitted and coupled to the integrated wire to be fixed to the anchor groove, the tether cover including a plurality of hooks provided thereon to be directly fixed to the panel and to form a plurality of fixing areas to which the tether cover is reliably fixed, thereby having an effect of reducing the number of components for assembly of the tether cover and simplifying a structure of an assembly of the tether cover.

In one embodiment, the present disclosure provides a tether anchor assembly for a vehicle, the tether anchor assembly including a seat frame including a support panel coupled to a back frame, the support panel including an anchor groove provided therein, and a mounting wire exposed to an outside through the anchor groove, and a tether cover configured to allow the mounting wire to be fitted and coupled to an inside thereof and to be exposed to the outside through the anchor groove when inserted into the anchor groove, and to be directly coupled to the support panel to fix a position of insertion thereof into the anchor groove.

In a preferred embodiment, the mounting wire may be connected to an inside of the back frame in a horizontal direction and coupled thereto, and may be fixed in position on the support panel by a coupling member.

In another preferred embodiment, the mounting wire may have a center portion formed to be bent to protrude convexly, the bent center portion being exposed to the outside through the anchor groove, in a state of being fixed in position on the support panel.

In still another preferred embodiment, the support panel may include a plurality of coupling holes formed along an outer peripheral surface of the anchor groove, and the tether cover may include a plurality of coupling hooks inserted into the plurality of coupling holes when inserted into the anchor groove and may be fixed to the anchor groove when the mounting wire is coupled to the inside thereof.

In yet another preferred embodiment, the tether cover may include a main body having a shape corresponding to a shape of the anchor groove and including a mounting hole configured to allow the mounting wire to be fitted and coupled thereto, a coupling guide formed to be integrated with an open upper outer peripheral surface of the main body, the coupling guide including the coupling hook formed to protrude in a direction toward the coupling hole, and a support member formed to protrude from opposite side surfaces of the main body and configured to support the mounting wire in a state in which the main body is inserted into the anchor groove.

In still yet another preferred embodiment, the main body may include an open area cut into opposite sides and may be made of a deformable material, the open area being selectively forcibly opened by the mounting wire and allowing the mounting wire to be inserted into and fixed inside the mounting hole.

In a further preferred embodiment, the mounting hole may be formed to correspond to a diameter of the mounting wire and to extend in a wedge shape, the mounting hole guiding the mounting wire to an inside thereof when the mounting wire is fitted and coupled thereto and fixing the mounting wire coupled thereto.

In another embodiment, vehicles are provided that comprise an apparatus as disclosed herein.

Other embodiments and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing a structure of a seat frame of a tether anchor assembly for a vehicle according to an embodiment of the present disclosure;

FIG. 2 is a view showing a structure to couple a tether cover to the seat frame of the tether anchor assembly for the vehicle according to the embodiment of the present disclosure;

FIG. 3 is a view showing the state in which the tether cover is separated from the tether anchor assembly for the vehicle according to the embodiment of the present disclosure;

FIG. 4 is a view showing the state in which the tether cover is coupled to the tether anchor assembly for the vehicle according to the embodiment of the present disclosure;

FIG. 5 is a view showing a fixing position at which the tether cover is fixed to the tether anchor assembly for the vehicle according to the embodiment of the present disclosure; and

FIG. 6 is a view showing a configuration of a tether anchor assembly for a vehicle of the related art.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Hereinafter, preferred embodiments according to the present disclosure will be described in detail with reference to the accompanying drawings.

Advantages and features of the present disclosure and a method of achieving the same will become apparent with reference to the embodiments described below in detail in conjunction with the accompanying drawings.

However, the present disclosure is not limited by the embodiments disclosed below, but will be implemented in various different forms. The embodiments are provided to ensure that the disclosure of the present disclosure is complete, and to completely inform the scope of the disclosure to those skilled in the art to which the present disclosure pertains. The present disclosure is defined only by the scope of the claims.

In addition, in the description of the present disclosure, when it is determined that related known technologies may obscure the gist of the present disclosure, a detailed description thereof will be omitted.

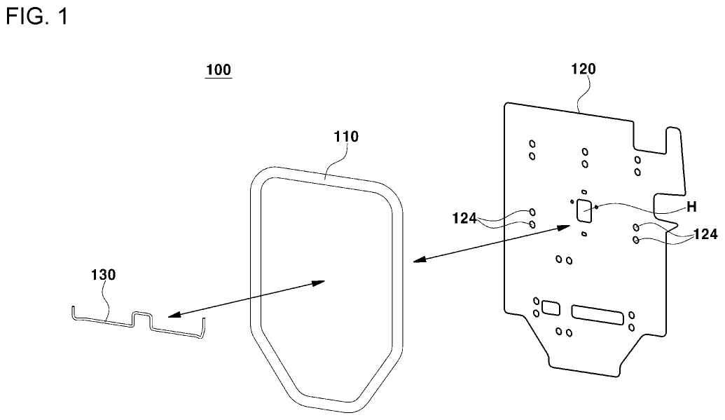

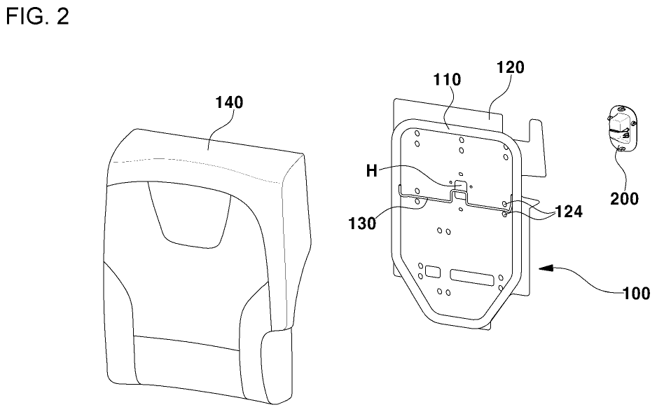

FIG. 1 is a view showing a structure of a seat frame of a tether anchor assembly for a vehicle according to an embodiment of the present disclosure, and FIG. 2 is a view showing a structure to couple a tether cover to the seat frame of the tether anchor assembly for the vehicle according to the embodiment of the present disclosure.

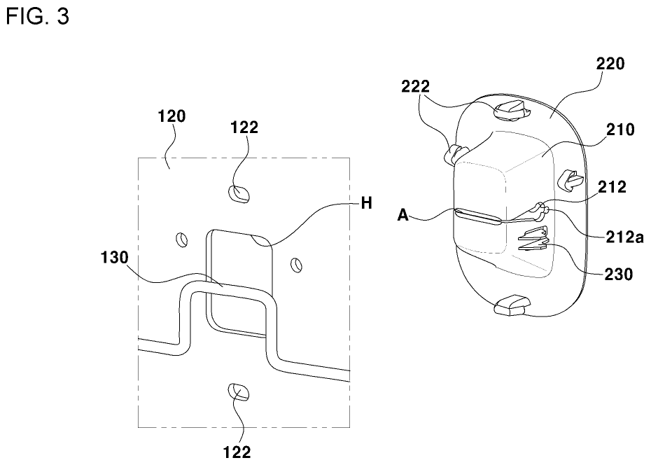

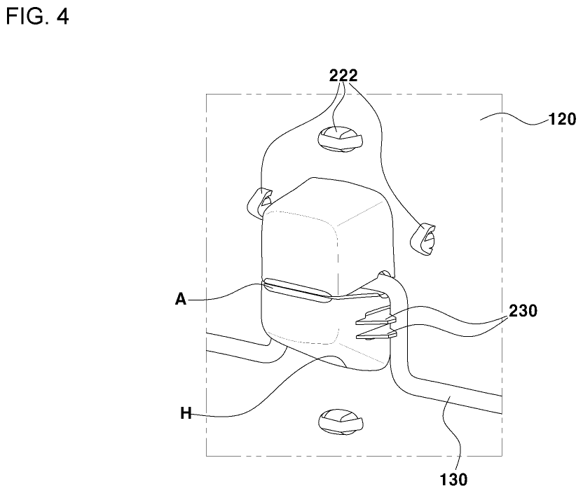

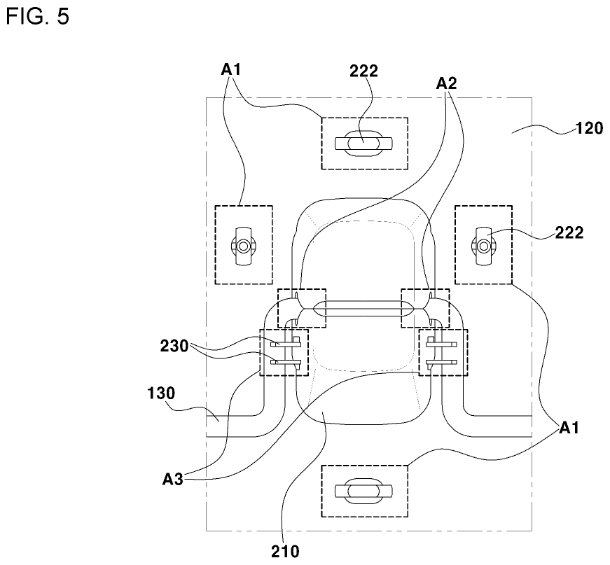

FIG. 3 is a view showing the state in which the tether cover is separated from the tether anchor assembly for the vehicle according to the embodiment of the present disclosure, FIG. 4 is a view showing the state in which the tether cover is coupled to the tether anchor assembly for the vehicle according to the embodiment of the present disclosure, and FIG. 5 is a view showing a fixing position at which the tether cover is fixed to the tether anchor assembly for the vehicle according to the embodiment of the present disclosure.

As shown in FIG. 2, the tether anchor assembly for the vehicle according to the embodiment may include a seat frame 100 and a tether cover 200.

In general, the seat frame 100 may be divided into a front seat and a rear seat, and the rear seat may include a child seat fixing device.

The child seat fixing device may be commonly referred to as a tether anchor. In order to fix the child seat, a lower anchor may be provided at a lower end portion of the rear seat, and a tether anchor may be provided at an upper end portion thereof.

As shown in FIG. 1, an assembly for the tether anchor may include a back frame 110, a support panel 120, and a mounting wire 130.

That is, the seat frame 100 may include the back frame 110 manufactured by press molding to obtain the rigidity of a seat, the support panel 120 to which the back frame 110 is coupled, and the mounting wire 130, a center portion of which is exposed to the outside from a rear surface of a seat through an anchor groove H in the support panel 120 in the state in which a seat covering pad 140 is coupled to a front side of the seat.

Here, the mounting wire 130 may be provided to have a predetermined length, and may be connected to one side of the back frame 110 and the other side thereof in a horizontal direction by welding or the like. In detail, the mounting wire 130 may be passed through a coupling hole 124 in the support panel 120 and may be knotted to be fixed thereto with a coupling member (not shown) such as a wire or the like, whereby the mounting wire 130 is fixed to the support panel 120.

As shown in FIG. 3, the mounting wire 130 may have a center portion bent in a ‘⊏’ shape in the state of being fixed in position on the support panel 120.

More preferably, the mounting wire 130 may be formed so that the bent center portion thereof is exposed to the outside through the anchor groove H, thereby guiding a coupling position of the tether cover 200 when the tether cover 200 is fitted and coupled to the anchor groove H from the rear surface of the seat.

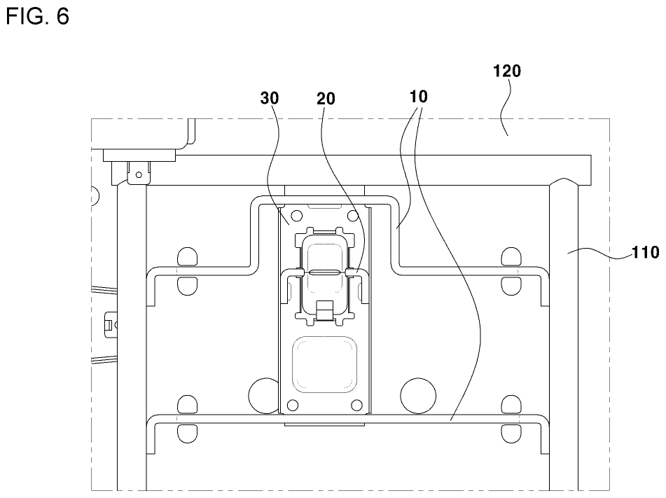

In the related art, a structure in which the tether cover 200 is fitted and coupled to the support panel 120 from a rear surface of the support panel 120, as shown in FIG. 6, includes a pair of wires 10 having opposite end portions respectively coupled to the back frame 110, a top tether wire 20, and a tether bracket 30 to which the wires 10 and the top tether wire 20 are coupled by welding or the like. In detail, the top tether wire 20 is exposed to the outside at the rear surface of the seat, thereby serving to fix the position of the tether cover 200 when the tether cover 200 is fitted and coupled thereto.

However, the above-described structure of the related art may significantly increase the number of components required to fix the tether cover 200, thereby causing a problem of increased material costs, weight, and the like.

In contrast, as shown in FIG. 2, the seat frame 100 according to the embodiment may include the single mounting wire 130 playing the role of the pair of wires 10 and the top tether wire 20 of the related art. In addition, since the tether cover 200 is directly fixed to the support panel 120, the structure of the tether bracket 30 may also be eliminated, thereby significantly reducing the number of components compared to the structure of the related art and reducing material costs, weight, and the like.

Meanwhile, when the tether cover 200 is inserted into the anchor groove H formed in the support panel 120, the mounting wire 130 may be fitted and coupled to an inside of the tether cover 200 and may be exposed to the outside from the rear surface of the seat through the anchor groove H.

More specifically, the tether cover 200 may be formed in a shape corresponding to a shape of the anchor groove H, and may have a structure in which the inside thereof is open. Accordingly, when the tether cover 200 is fitted and coupled to the mounting wire 130 to be mounted in the anchor groove H, the center portion of the mounting wire 130 is located at the open inside of the tether cover 200 and is exposed to the outside through the anchor groove H, thereby making it possible not only to firmly fix the mounting wire 130 to the tether cover 200 but also to provide a finished appearance around the anchor groove H. Accordingly, the mounting wire 130, which is exposed to the outside, provides a locking function of allowing the child seat to be locked and fixed thereto.

Here, the support panel 120 may include a plurality of coupling holes 122 formed along an outer peripheral surface of the anchor groove H. When the tether cover 200 is inserted into the anchor groove H, a plurality of coupling hooks 222 are inserted into the coupling holes 122. As a result, as shown in FIG. 4, the mounting wire 130 is coupled to an internal mounting hole 212, and the coupling hook 222 is also inserted into the coupling hole 122 to be coupled thereto, thereby achieving reliable fixing (mounting) of the tether cover 200.

To this end, the tether cover 200 may include a main body 210, a coupling guide 220, and a support member 230.

The main body 210 may be formed in a shape corresponding to the shape of the anchor groove H, that is, in the shape of a hexahedron, an open top of which is to be inserted into the anchor groove H. In detail, the main body 210 is formed to have a predetermined depth, and the mounting wire 130 is exposed to the inside of the main body 210 when the main body 210 is inserted into the anchor groove H.

Preferably, the main body 210 may be formed to have an internal area that gradually becomes smaller from an open upper portion thereof to a lower portion thereof. Accordingly, the main body 210 is easily inserted into the anchor groove H, and an upper edge thereof is in contact with an inner peripheral surface of the anchor groove H in the state in which the main body 210 is completely inserted thereinto, thereby preventing any movement of the main body 210 in the anchor groove H.

The main body 210 may include an open area A, cut into opposite sides and located at the center of the lower portion thereof, and may be made of a deformable material, that is, an elastic material. Accordingly, when the open area A is pressed by the mounting wire 130 to selectively open the same, the mounting wire 130 is positioned in the mounting hole 212, and, as such, the main body 210 is fixed into the anchor groove H.

That is, when the main body 210 is pressed toward the mounting wire 130, which is exposed to the outside through the anchor groove H, the open area A in the main body 210 may be selectively opened by the mounting wire 130. In this case, when the main body 210 is further pushed in the direction in which the same is inserted into the anchor groove H, the mounting wire 130 is positioned in the internal mounting hole 212, thereby fixing the main body 210 to the anchor groove H.

Here, the mounting hole 212 may be formed so that an inside thereof corresponds to the diameter of the mounting wire 130, the inside of the mounting hole 212 being formed to extend in a wedge shape (refer to FIGS. 3 and 4). Accordingly, the mounting wire 130 may be easily guided to the inside of the mounting hole 212 when the mounting wire 130 is fitted and coupled thereto, thereby allowing the mounting wire 130 to be reliably fixed to the inside of the mounting hole 212.

In addition, an extension guide 212a may be provided inside the mounting hole 212. When the open area A of the main body 210 is widened by the mounting wire 130, the main body 210 may be opened in opposite directions with respect to the center of the extension guide 212a, thereby making it possible to easily open the open area A. The coupling guide 220 may be formed to be integrated with an open upper outer peripheral surface of the main body 210 to guide the position for insertion of the main body 210 when the same is inserted into the anchor groove H. Further, the coupling guide 220 may guide the main body 210 to be fixedly positioned at an entrance of the anchor groove H by allowing the coupling hook 222 formed thereon to be coupled to the coupling hole 122 formed at the entrance thereof.

In detail, as shown in FIG. 3, the coupling guide 220 may include the coupling hook 222 formed to protrude in a direction toward the coupling hole 122.

The coupling hook 222 may be preferably formed to have a larger size than the diameter of the coupling hole 122, and more preferably, may be formed to have an inclination to facilitate insertion into the coupling hole 122.

When the mounting wire 130 is fitted and coupled to the mounting hole 212 in the main body 210, the coupling guide 220 may be primarily fixed to the anchor groove H. Next, when the coupling guide 220 is secondarily fixedly positioned at the entrance of the anchor groove H, the coupling hook 222 thereof is inserted into and fixed into the coupling hole 122, thereby effectively securing the position at which the tether cover 200 is fixed to the support panel 120.

As shown in FIG. 4, a support member 230 may be formed to protrude from opposite side surfaces of the main body 210, and to be fixedly positioned at the mounting wire 130 to support the mounting wire 130 in the state in which the main body 210 is inserted into the anchor groove H.

That is, the support member 230 may be provided to preemptively prevent the main body 210 from moving in an insertion direction together with the coupling guide 220, and support a portion of the mounting wire 130 bent in a “┐” shape from opposite sides of a center portion of the mounting wire 130 in the state in which the mounting wire 130 is positioned inside the mounting hole 212, thereby preemptively preventing the center portion of the mounting wire 130 from moving in the mounting hole 212.

As shown in FIG. 5, the tether cover 200 having the above-described structure may form eight fixing areas, specifically including an area A1 in which the four coupling hooks 222 and the coupling holes 122 are coupled to each other, an area A2 in which the mounting wire 130 is fixed to the mounting hole 212, and an area A3 in which the mounting wire 130 is supported by the support member 230. Accordingly, the number of components, material costs, weight, and the like may be reduced compared with the structure of the related art shown in FIG. 6, thereby simplifying a structure of an assembly of the tether cover 200.

According to the present disclosure, an integrated wire capable of guiding mounting of a child seat and fixing a back frame and a panel may be installed in the back frame which determines the rigidity of a seat. The integrated wire is exposed to an outside through an anchor groove, and a tether cover is fitted and coupled to the integrated wire to be fixed to the anchor groove. Further, the tether cover includes a plurality of hooks to be directly fixed to the panel and to form a plurality of fixing areas to which the tether cover is reliably fixed, thereby having an effect of simplifying a structure of an assembly of the tether cover.

Further, while a structure of a tether anchor assembly of the related art includes many components such as two fixing wires to be mounted on a fixing bracket, the fixing bracket, a wire installed in the fixing bracket, and a tether cover, the present disclosure may include only the integrated wire and the tether cover. As a result, the number of components can be reduced compared to the related art, thereby having effects of reducing material costs, weight, and the like.

As is apparent from the above description, the present disclosure may provide a tether anchor assembly for a vehicle including an integrated wire capable of guiding mounting of a child seat and fixing a back frame and a panel, the integrated wire being installed in the back frame, which determines the rigidity of a seat, and being exposed to an outside through an anchor groove, and a tether cover fitted and coupled to the integrated wire to be fixed to the anchor groove, the tether cover including a plurality of hooks provided thereon to be directly fixed to the panel and to form a plurality of fixing areas to which the tether cover is reliably fixed, thereby having an effect of simplifying a structure of an assembly of the tether cover.

Further, compared with a structure of a tether anchor assembly of the related art including two fixing wires to be mounted on a fixing bracket, the fixing bracket, a wire installed in the fixing bracket, and a tether cover, the present disclosure may include only the integrated wire and the tether cover, and, as such, the number of components can be reduced compared to the related art, thereby having an effect of reducing material costs, weight, and the like.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A tether anchor assembly for a vehicle comprising:
a seat frame comprising a support panel coupled to a back frame, the support panel comprising an anchor groove provided therein, and a mounting wire exposed to an outside through the anchor groove; and
a tether cover configured to allow the mounting wire to be fitted and coupled to an inside thereof and to be exposed to the outside through the anchor groove when inserted into the anchor groove, and to be directly coupled to the support panel to fix a position of insertion thereof into the anchor groove.

2. The tether anchor assembly of claim 1, wherein the mounting wire is connected to an inside of the back frame in a horizontal direction and coupled thereto, and is fixed in position on the support panel by a coupling member.

3. The tether anchor assembly of claim 2, wherein the mounting wire has a center portion formed to be bent to protrude convexly, the bent center portion being exposed to the outside through the anchor groove, in a state of being fixed in position on the support panel.

4. The tether anchor assembly of claim 1, wherein:
the support panel comprises a plurality of coupling holes formed along an outer peripheral surface of the anchor groove, and
the tether cover comprises a plurality of coupling hooks inserted into the plurality of coupling holes when inserted into the anchor groove, and is fixed to the anchor groove when the mounting wire is coupled to the inside thereof

5. The tether anchor assembly of claim 4, wherein the tether cover comprises:
a main body having a shape corresponding to a shape of the anchor groove and comprising a mounting hole configured to allow the mounting wire to be fitted and coupled thereto,
a coupling guide formed to be integrated with an open upper outer peripheral surface of the main body, the coupling guide comprising the coupling hook formed to protrude in a direction toward the coupling hole, and
a support member formed to protrude from opposite side surfaces of the main body and configured to support the mounting wire in a state in which the main body is inserted into the anchor groove.

6. The tether anchor assembly of claim 5, wherein the main body comprises an open area cut into opposite sides and is made of a deformable material, the open area being selectively forcibly opened by the mounting wire and allowing the mounting wire to be inserted into and fixed inside the mounting hole.

7. The tether anchor assembly of claim 5, wherein the mounting hole is formed to correspond to a diameter of the mounting wire and to extend in a wedge shape, the mounting hole guiding the mounting wire to an inside thereof when the mounting wire is fitted and coupled thereto and fixing the mounting wire coupled thereto.

8. The tether anchor assembly of claim 5, wherein the main body is formed to have an internal area that gradually becomes smaller from an open upper portion thereof to a lower portion thereof.

9. The tether anchor assembly of claim 5, wherein an extension guide is provided inside the mounting hole.

10. The tether anchor assembly of claim 5, wherein the main body is in the shape of a hexahedron.

11. The tether anchor assembly of claim 4, wherein the coupling hook is formed to have a larger size than the diameter of the coupling hole.

12. The tether anchor assembly of claim 4, wherein the coupling hook is formed to have an inclination to facilitate insertion into the coupling hole.

13. A vehicle comprising the tether anchor assembly of claim 1.
